(19) United States
(12) Patent Application Publication
(10) Pub. No.: US 2007/0059975 A1
(43) Pub. Date: Mar. 15, 2007

(54) Connector having light pipe formed therein

(76) Inventor: Peter J. Walsh, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/226,209

(22) Filed: Sep. 15, 2005

(51) Int. Cl. H01R 3/00

(52) U.S. Cl. 439/490

(57) ABSTRACT

A connector for connecting first and second electronic devices together. The first electronic device has a light emitting device to indicate a status, and the connector body forms a light pipe to guide light from the light emitting device to outside of the connector body so that the guided light can be viewed outside of the connector to thereby determine the status of the connection.

### BACKGROUND OF THE INVENTION

### Description of the Related Art

Communications interfaces often require LED status indicators that report the current condition of a connection, i.e. the presence or absence of a signal, a signal defect, a frame sync, an optical or electrical signal level and/or a bit error rate above an applicable standard's specifications or a set threshold.

The LED status connectors are often placed locally on a front panel of a host device so that a user may visually determine the condition of a connection and quickly resolve problems in the communications interface.

However, with the constant push toward higher density interface connectors on instrument front panel space, the convenience of LED status indicators on the front panel is outweighed by the cost of space requirements.

Therefore, there is a need for a device that can show the status of a connection without devoting front panel space to status indicators.

### BRIEF DESCRIPTION OF THE DRAWINGS

Aspects and advantages of the present invention will become apparent and more readily appreciated from the following description of the preferred embodiment, taken in conjunction with the accompanying drawings of which:

FIG. 1 is a perspective view of a first electronic device connected to a second electronic device through a connector according to an embodiment of the present invention;

FIG. 2 is a side view of the connector shown in FIG. 1, according to an embodiment of the present invention;

FIG. 3 is a side view of a connector, according to another embodiment of the present invention;

FIG. 4 is a side view of a connector, according to yet another embodiment of the present invention; and

FIG. 5 is a side view of a connector, according to still another embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to like elements throughout.

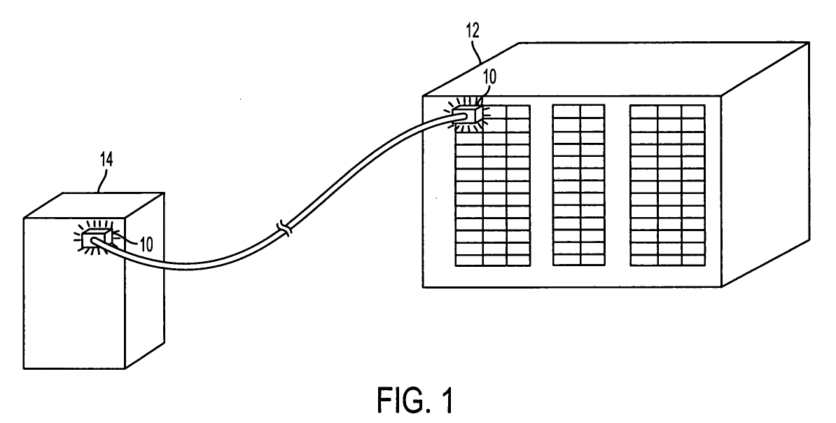

FIG. 1 is a perspective view of a first electronic device connected to a second electronic device through a connector according to an embodiment of the present invention. Referring now to FIG. 1, a connector 10 connects a first electronic device 12 to a second electronic device 14.

The first electronic device 12 includes a light emitting device (not shown in FIG. 1) to indicate a status. For example, the light emitting device might indicate the presence or absence of a signal, a signal defect, a frame sync, an optical or electrical signal level and/or a bit error rate above an applicable standard's specifications or a set threshold. The light emitting device might be, for example, a light emitting diode (LED). However, the present invention is not limited to a light emitting device being a light emitting diode, and other suitable light emitting devices can be used.

In an embodiment of the present invention, the connector 10 forms a light pipe to guide light from the light emitting device so that the guided light can be viewed outside of the connector 10 to thereby determine the status.

The connector 10 is made, for example, of a suitable material for forming a light pipe. The connector 10 might be made, for example, of plastic. However, embodiments of the present invention are not limited to the connector 10 being made of plastic, and other suitable materials can be used. Moreover, the connector 10 might be made of a clear material, such as a clear plastic, to thereby allow the light inside the light pipe to be viewed from outside of the connector 10. However, the present invention is not limited to the connector 10 being made of a clear material.

The first electronic device 12 may be, for example, a protocol analyzer. However, embodiments of the present invention are not limited to the first electronic device being a protocol analyzer. Instead of a protocol analyzer, any electronic device having a light emitting device to indicate a status may be used with the present invention. However, as protocol analyzers typically use an LED to emit light indicating a status, a connector according to embodiments of the present invention would be particularly useful when used with a protocol analyzer.

The second electronic device 14 may be connected to a communication link that is directly connected to the connector body, to thereby connect the first and second electronic devices 12, 14 together through the connector. However, embodiments of the present invention are not limited to the second electronic device 14 being connected to a communication link.

The connector 10 may, for example, be an LC or SC connector. However, embodiments of the present invention are not limited to an LC or SC connector.

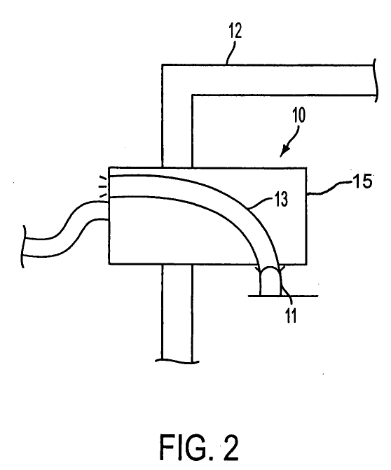

FIG. 2 is a side view of the connector 10 shown in FIG. 1, according to an embodiment of the present invention. Referring now to FIG. 2, the connector 10 has a connector body 15 connecting the first and second electronic device 12, 14 together. The first electronic device 12 has a light emitting device 11, such as an LED, to indicate a status. The connector body 15 forms a light pipe 13 to guide light from the light emitting device to outside of the connector body 15 so that the guided light can be viewed outside of the connector 10 to thereby determine the status.

As indicated above, the connector body 15 might be made, for example, of plastic. However, the present invention is not limited to the connector body 15 being made of plastic, and other suitable materials can be used. Moreover, as indicated above, the connector 10 might be, for example, an LC or SC connector. However, the present invention is not limited to the connector 10 being an LC or SC connector.

In FIG. 2, the light pipe 13 guides light to outside of the connector 10 so that the light can be viewed outside of the connector 10. However, in various embodiments of the present invention, a connector might include a nose into which light from a light pipe is guided. The nose would then illuminate for easy viewing by a person.

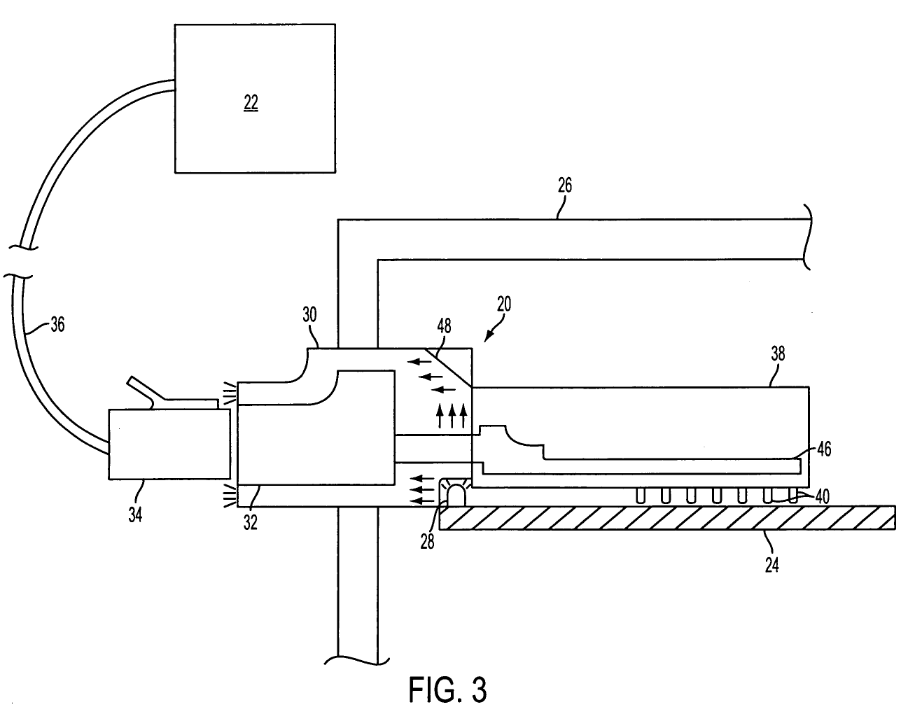

For example, FIG. 3 shows another embodiment of the present invention in which a nose is illuminated. Referring now to FIG. 3, a connector 20 is shown for connecting an electronic device 22 to, for example, a printed circuit board 24 contained within a host device 26. The printed circuit board 22 has, for example, a light emitting diode 28 to indicate a status. However, embodiments of the present invention are not limited to connecting to a printed circuit board. Instead of a printed circuit board, any electronic device having a light emitting device to indicate a status may be used with embodiments of the present invention.

In the embodiment in FIG. 3, the connector 20 includes a rear portion 38 as a connector body. A nose 30 is connected to the rear portion 38.

The nose 30 is made, for example, of clear plastic adapted to protrude from the host device 26. However, embodiments of the present invention are not limited to the nose being made of clear plastic, and other suitable materials can be used.

The nose includes, for example, a receptacle 32 formed at the front of the nose 30. The receptacle is adapted, for example, for insertion of a plug 34 attached to the electronic device 22 through a cable 36.

The rear portion 38 of the connector 20 is connected to the nose 30. The rear portion 38 is adapted to be inserted into the host device 26. The rear portion 38 also includes connector electronics such as, for example, a magnetic circuit 46. However, the present invention is not limited to the rear portion 38 including connector electronics, or to the connector electronics being any particular type of electronics.

The connector 20 includes a pin connector 40 protruding from the rear portion 38. The pin connector 40 is adapted to connect to the printed circuit board 24 contained within the host device 26.

The nose 30 is formed as a light pipe to guide light from the light emitting diode 28 to outside of the connector 20.

An internal surface of the nose 30 is faceted, for example, to form a reflective surface 48 positioned opposite to the light emitting diode 28 to reflect light from the light emitting diode 28, whereby light is reflected by the reflective surface 48, and further illuminates the nose 30 of the connector 20.

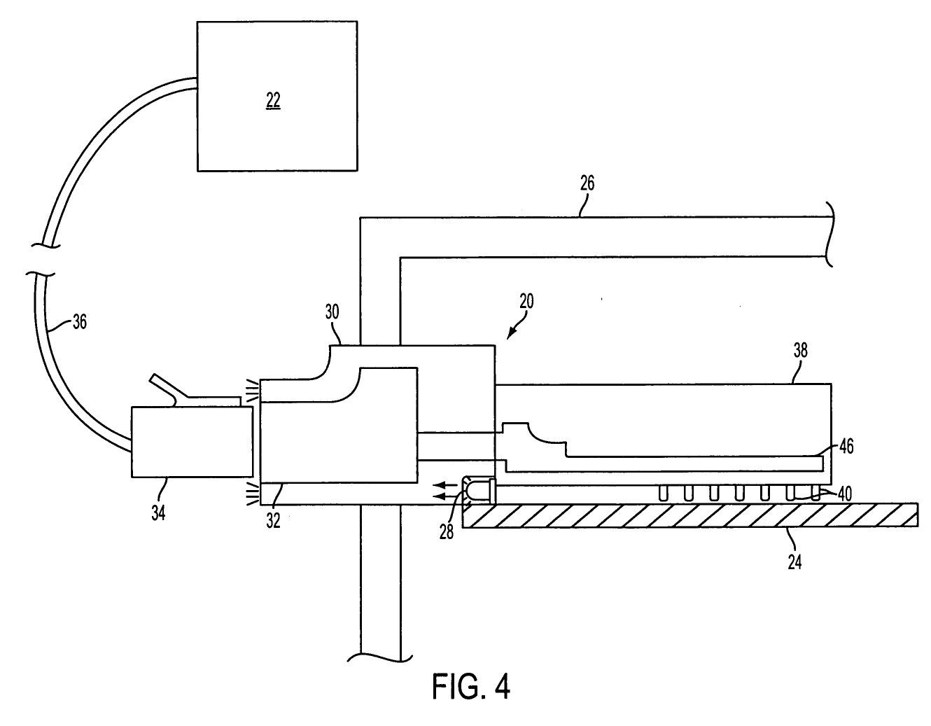

FIG. 4 is a side view of a connector, according to yet another embodiment of the present invention.

As shown in FIG. 4, the light emitting diode 28 may be vertically mounted to illuminate nose directly without the use of the reflective surface 48.

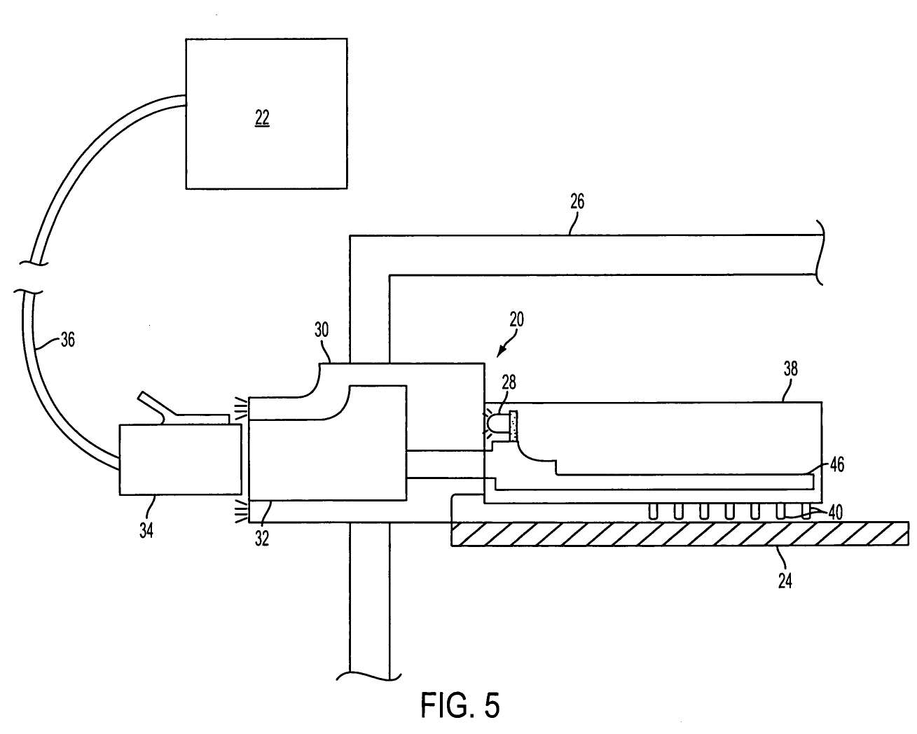

FIG. 5 is a side view of a connector, according to yet another embodiment of the present invention.

As shown in FIG. 5, the light emitting diode 48 may be mounted in the rear portion 38 to indicate the status of the connection. For example, the light emitting diode 28 may be vertically mounted on the magnetic circuit 46 to illuminate the nose directly without the use of the reflective surface 48.

In an embodiment of the present invention, the light emitting diode 28 might be, for example, capable of emitting multiple colors, such as a Red Green Blue (RGB) light emitting diode. By using a multi-color light emitting diode, several combinations of colors and flash rates could define and indicate a wide variety of conditions unique to the task of protocol analysis and communication integrity. However, embodiments of the present invention are not limited to the light emitting diode being capable of multiple colors, and other types of light emitting diodes may be used with embodiments of the present invention.

Some examples of light emitting diode colors and flash rates/combination for a given level-one link connection could include: steady green=operating normally, no warning or errors; alternating green and yellow=operating, but with cautionary level-one problems; alternating green and red=operating, but has exceeded pre-set or user defined error rate threshold; steady or flashing yellow=operating below standard or signal detected but no frame sync; steady or flashing red=not operating and/or several error conditions. However, embodiments of the present invention are not limited to the flash rates/combinations described above, and other types of flash rates/combinations may be used with embodiments of the present invention.

The present invention relates to the use of light pipes. Light pipes are optical waveguides which guide light. Light pipes are known devices.

Various embodiments of the present invention show a connector as including a nose, rear portion, receptacle and other components. However the present invention is not limited to a connector all of the above listed components. For example, in some embodiments, a connector may be a single piece, the connector body having a light pipe formed therein or the connector body is the light pipe.

The present invention relates to the use of a light emitting device to indicate a status. The use of a light emitting device to indicate a status is known. “Status” is information describing a state of a condition. For example, a light emitting device might emit a light to indicating the presence or absence of a signal, a signal defect, a frame sync, an optical or electrical signal level and/or a bit error rate above an applicable standard's specifications or a set threshold. However, the present invention is not limited to any particular status information.

Although a few embodiments of the present invention have been shown and described, it would be appreciated by those skilled in the art that changes may be made in these embodiments without departing from the principles and spirit of the invention, the scope of which is defined in the claims and their equivalents.

1. A connector comprising:
a connector body connecting first and second electronic devices together, the first electronic device having a light emitting device to indicate a status, the connector body forming a light pipe to guide light from the light emitting device to outside of the connector body so that the guided light can be viewed outside of the connector to thereby determine the status.

2. The connector as in claim 1, wherein the light emitting device is a light emitting diode (LED).

3. The connector as in claim 1, wherein the connector body is made of plastic.

4. (canceled)

5. (canceled)

6. The connector as in claim 1, wherein the connector is an LC connector.

7. A connector for connecting an electronic device to a host device, the host device having at least one light emitting device to indicate a status, the connector comprising:
a first portion formed as a light pipe to guide light from the light emitting device to an exterior of the connector so that the guided light can be viewed outside of the connector; and
a second portion connected to the host device.

8. The connector of claim 7, wherein the first portion is connected to the electronic device.

9. The connector of claim 8, wherein the first portion is constructed of clear plastic.

10. The connector of claim 7, wherein the light emitting device is vertically mounted.

11. The connector of claim 7, wherein an internal surface of the first portion is faceted to form a reflective surface to increase light reflection.

12. The connector of claim 7, wherein the light emitting device is horizontally mounted.

13. The connector of claim 7, wherein the light emitting device is a multi-color light emitting diode.

14. A connector for connecting an electronic device to a printed circuit board contained within a host device, the connector comprising:
a nose adapted to protrude from the host device, the nose forming a light pipe to guide light from a light emitting diode indicating a status;
a receptacle formed at a front of the nose, the receptacle being adapted for insertion of a plug attached to the electronic device through a cable;
a rear portion connected to the nose, the rear portion being adapted to be inserted into the host device; and
a pin connector protruding from the rear portion, the pin connector being adapted to connect to the printed circuit board contained within the host device.

15. The connector according to claim 14, wherein the nose is constructed of clear plastic.

16. The connector according to claim 14, wherein the light emitting diode is mounted in the rear portion.

17. The connector according to claim 14, wherein the light emitting diode is a multi-color light emitting diode.
